(19) United States
(12) Patent Application Publication
(10) Pub. No.: US 2013/0269332 A1
(43) Pub. Date: Oct. 17, 2013

(54) ENERGY RECYCLING SYSTEM FOR A CONSTRUCTION APPARATUS

(71) Applicants: Ok-Jin Suk, Changwon-si (KR); Chun-Han Lee, Gimhae-si (KR)

(72) Inventors: Ok-Jin Suk, Changwon-si (KR); Chun-Han Lee, Gimhae-si (KR)

(73) Assignee: VOLVO CONSTRUCTION EQUIPMENT AB, Eskilstuna (SE)

(21) Appl. No.: 13/996,797

(22) PCT Filed: Dec. 27, 2010
(86) PCT No.: PCT/KR10/09354

§ 371 Date: Jun. 21, 2013

(51) Int. Cl. F15B 11/20; E02F 9/20; F15B 11/17

(52) U.S. Cl. CPC F15B 11/205; F15B 11/17; E02F 9/2025
USPC 60/420; 91/525

(57) ABSTRACT

An energy recycling system is disclosed. When a construction apparatus performs a combined operation of a boom down operation and an arm out operation, hydraulic energy returned in the boom down operation is recycled for the arm out operation by the energy recycling system. An energy recycling system for a construction apparatus according to the present invention includes: a first hydraulic pump; a second hydraulic pump; an arm cylinder including a low-pressure chamber connected to the first hydraulic pump through an arm out supply passage; an arm out return passage connecting a high pressure chamber of the arm cylinder to a hydraulic tank; a boom cylinder including a low-pressure chamber connected to the second hydraulic pump through a boom down supply passage; a boom down return passage connecting a high pressure chamber of the boom cylinder to a hydraulic tank; a joining and recycling passage connecting the boom down return passage and the arm out supply passage to each other in parallel; a recycling passage connecting the boom down return passage and the boom down supply passage to each other in parallel; and a plurality of detecting means that detect pressure of the arm cylinder and pressure of the boom cylinder, respectively, to determine whether a hydraulic fluid, returned from the boom cylinder in a combined operation of a boom down operation and an arm out operation, is recycled.

### FIELD OF THE INVENTION

The present invention relates to an energy regeneration system for a construction machine, which enables energy to be regenerated when the construction machine performs a combined operation of boom down and arm out. More particularly, the present invention relates to an energy regeneration system for a construction machine, which enables hydraulic energy returned by the boom down operation to be regenerated during the arm out operation.

### BACKGROUND OF THE INVENTION

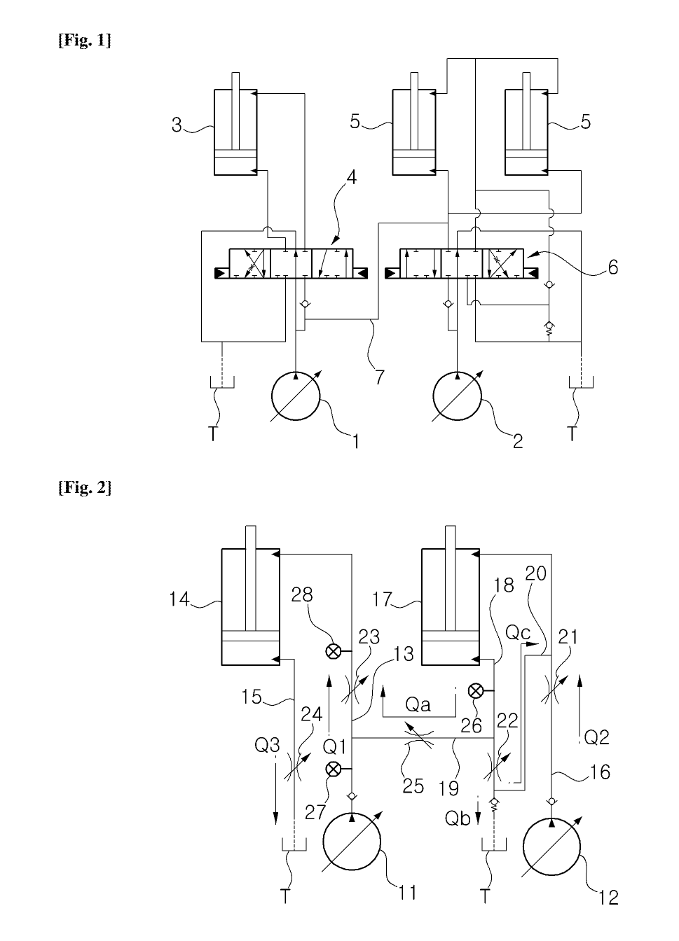

A hydraulic system in which a boom cylinder and an arm cylinder are joined to each other in accordance with the prior art as shown in FIG. 1 includes:

first and second variable displacement hydraulic pumps (hereinafter, referred to as “first and second hydraulic pumps”) 1 and 2 that are connected to an engine (not shown);

an arm cylinder 3 that is connected to the first hydraulic pump 1;

a control valve 4 that is mounted in a discharge flow path of the first hydraulic pump 1 and controls the arm in and out operation of the arm cylinder 3;

a boom cylinder 5 that is connected to the second hydraulic pump 2;

a control valve 6 that is mounted in a discharge flow path of the second hydraulic pump 2 and controls the boom up and down operation of the boom cylinder 5; and

a confluence flow path 7 that connects the discharge flow path of the first hydraulic pump 1 and the discharge flow path of the second hydraulic pump 2 to each other in parallel, and allows the hydraulic fluids discharged from the first and second hydraulic pumps 1 and 2 to join each other therein depending on the work condition to secure the drive speed of a corresponding actuator.

In the hydraulic system as constructed above, when the boom down operation is performed by shifting a spool in a left direction on the drawing in response to a pilot signal pressure supplied to the control valve 6, the hydraulic fluid discharged from the second hydraulic pump 2 is supplied to a small chamber of the boom cylinder 5 via the control valve 6. In this case, some of the hydraulic fluid returned from a large chamber of the boom cylinder 5 is supplied to the small chamber of the boom cylinder 5.

As such, during the boom down operation, some of the hydraulic fluid in a high pressure state, which is returned to a second hydraulic tank T from the large chamber of the boom cylinder 5, is supplied to the small chamber in a low pressure state of the boom cylinder 5 and is regenerated in the small chamber, so that the efficiency of the hydraulic energy discharged from the second hydraulic pump 2. In this case, the hydraulic fluid is supplied to the small chamber by a difference in the cross-sectional area of the boom cylinder 5, and the remaining hydraulic fluid is returned to the second hydraulic tank T.

In addition, during the arm out operation alone, a discharge flow rate in which the flow rates of the hydraulic fluids from the first hydraulic pump 1 and the second hydraulic pump 2 join each other is required so that the construction machine can be driven under the condition of a high-load generated from the arm cylinder 3.

Meanwhile, an excavation work is generally performed through a combined operation of boom down and arm out in order to increase the work efficiency in terms of the properties of an excavator or the like. In this case, the hydraulic fluid supplied to the boom cylinder 5 from the second hydraulic pump 2 cannot be supplied to the arm cylinder 3 during the arm out operation due to a low pressure of a supply-side hydraulic fluid during the boom down operation.

Thus, the conventional hydraulic system entails a problem in that the workability of the arm out operation during the combined operation of boom down and arm out is relatively remarkably deteriorated as compared to that of the arm out operation alone.

### DETAILED DESCRIPTION OF THE INVENTION

### Technical Problems

Accordingly, the present invention was made to solve the aforementioned problem occurring in the prior art, and it is an object of the present invention to provide an energy regeneration system for a construction machine, in which when the construction machine performs a combined_operation of boom down and arm out, hydraulic energy returned by the boom down operation can be supplied to the arm cylinder, thereby improving the workability of the arm out operation.

Another object of the present invention to provide an energy regeneration system for a construction machine, in which a supply flow path (meter-in) and a return flow path (meter-out) with respect to a hydraulic actuator are controlled independently, and the pressure of the hydraulic actuator is detected in real-time, so that the hydraulic fluid can be supplied to an arm cylinder at the time of performing the combined operation.

Technical Solution To accomplish the above object, in accordance with an embodiment of the present invention, there is provided an energy regeneration system for a construction machine, which includes:
first and second variable displacement hydraulic pumps;
an arm cylinder having a low-pressure chamber connected to the first hydraulic pump through an arm out supply flow path;
an arm out return flow path configured to connect a high-pressure chamber of the arm cylinder to a first hydraulic tank;
a boom cylinder having a low-pressure chamber connected to the second hydraulic pump through a boom down supply flow path;
a boom down return flow path configured to connect a high-pressure chamber of the boom cylinder to a second hydraulic tank;
a confluence and regeneration flow path configured to connect the boom down return flow path and the arm out supply flow path to each other in parallel, and regeneratingly supply some of hydraulic fluid, which is returned to the second hydraulic tank by a boom down operation, to the arm out supply flow path during a combined operation of boom down and arm out;
a regeneration flow path configured to connect the boom down return flow path and the boom down supply flow path to each other in parallel, and regeneratingly supply some of hydraulic fluid, which is returned to the second hydraulic tank by the boom down operation, to the low-pressure chamber of the boom cylinder; and
detection means configured to detect the pressure of the arm cylinder and the pressure of the boom cylinder in order to determine whether or not the hydraulic fluid returned to the second hydraulic tank from the boom cylinder can be regenerated during the combined operation of the boom down and the arm out.

According to a more preferable embodiment, the energy regeneration system for a construction machine further includes: a first variable flow rate control valve mounted in the boom down supply flow path and configured to control the hydraulic fluid supplied to the low-pressure chamber of the boom cylinder from the second hydraulic pump; and a second variable flow rate control valve mounted in the boom down return flow path and configured to control the hydraulic fluid returned to the second hydraulic tank from the high-pressure chamber of the boom cylinder.

In accordance with an embodiment of the present invention, the energy regeneration system for a construction machine further includes: a third variable flow rate control valve mounted in the arm out supply flow path and configured to control the hydraulic fluid supplied to the low-pressure chamber of the arm cylinder from the first hydraulic pump; and a fourth variable flow rate control valve mounted in the arm out return flow path and configured to control the hydraulic fluid returned to the first hydraulic tank T from the high-pressure chamber of the arm cylinder.

In accordance with an embodiment of the present invention, the energy regeneration system for a construction machine further includes: a fifth variable flow rate control valve mounted in the confluence and regeneration flow path and configured to control the hydraulic fluid supplied to the low-pressure chamber of the arm cylinder from the high-pressure chamber of the boom cylinder.

The detection means includes a first pressure sensor configured to detect the pressure generated from the high-pressure chamber of the boom cylinder, and a second pressure sensor configured to detect a discharge pressure supplied to the low-pressure chamber of the arm cylinder from the first hydraulic pump.

### ADVANTAGEOUS EFFECT

The energy regeneration system for a construction machine in accordance with an embodiment of the present invention as constructed above has the following advantages.

When an excavator performs a combined operation of boom down and arm out, hydraulic energy returned by the boom down operation can be supplied to the arm cylinder, thereby improving the workability of the arm out operation.

In addition, the supply flow path (meter-in) and the return flow path (meter-out) with respect to the hydraulic actuator are controlled independently, and the pressure of the hydraulic actuator (i.e., boom cylinder or the like) is detected in real-time, thereby reducing the manufacturing cost owing to compactness of the hydraulic system.

### BRIEF DESCRIPTION OF THE INVENTION

The above objects, other features and advantages of the present invention will become more apparent by describing the preferred embodiments thereof with reference to the accompanying drawings, in which:

FIG. 1 is a circuit diagram showing a hydraulic system in which a boom cylinder and an arm cylinder are joined to each other in accordance with the prior art;

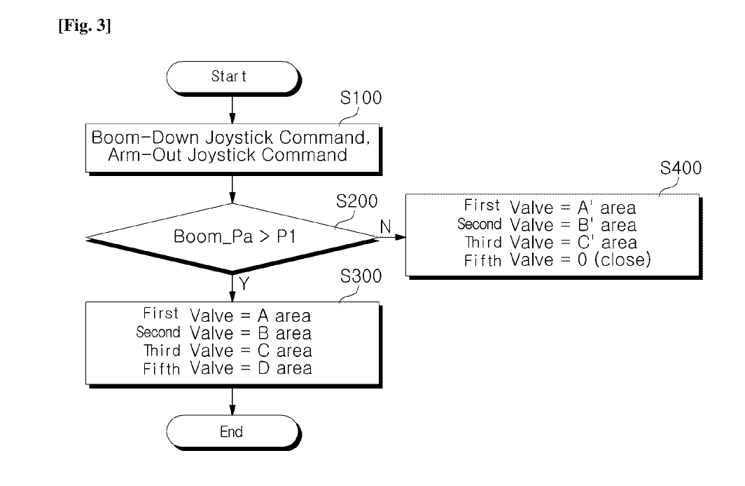

FIG. 2 is a circuit diagram showing an energy regeneration system for a construction machine in accordance with an embodiment of the present invention; and

FIG. 3 is a flowchart showing the supply of a hydraulic fluid regenerated by a boom down operation to an arm cylinder in an energy regeneration system for a construction machine in accordance with an embodiment of the present invention.

### EXPLANATION ON REFERENCE NUMERALS OF MAIN ELEMENTS IN THE DRAWINGS

11: first variable displacement hydraulic pump
12: second variable displacement hydraulic pump
13: arm out supply flow path
14: arm cylinder
15: arm out return flow path
16: boom down supply flow path
17: boom cylinder
18: boom down return flow path
19: confluence and regeneration flow path
20: regeneration flow pat
21: first variable flow rate control valve
22: second variable flow rate control valve
23: third variable flow rate control valve
24: fourth variable flow rate control valve
25: fifth variable flow rate control valve
26: first pressure sensor
27: second pressure sensor
28: third pressure sensor

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

An energy regeneration system for a construction machine in accordance with an embodiment of the present invention as shown in FIG. 2 includes:
first and second variable displacement hydraulic pumps (hereinafter, referred to as “first and second hydraulic pumps”) 11 and 12 connected to an engine (not shown);
an arm cylinder 14 having a low-pressure chamber (referring to small chamber) connected to the first hydraulic pump 11 through an arm out supply flow path 13;
an arm out return flow path 15 configured to connect a high-pressure chamber (referring to large chamber) of the arm cylinder 14 to a first hydraulic tank T;
a boom cylinder 17 having a low-pressure chamber (referring to small chamber) connected to the second hydraulic pump 12 through a boom down supply flow path 16;
a boom down return flow path 18 configured to connect a high-pressure chamber (referring to small chamber) of the boom cylinder 17 to a second hydraulic tank T;
a confluence and regeneration flow path 19 configured to connect the boom down return flow path 18 and the arm out supply flow path 13 to each other in parallel, and regeneratingly supply some of hydraulic fluid, which is returned to the second hydraulic tank T by a boom down operation, to the arm out supply flow path 13 during a combined operation of boom down and arm out;
a regeneration flow path 20 configured to connect the boom down return flow path 18 and the boom down supply flow path 16 to each other in parallel, and regeneratingly supply some of hydraulic fluid, which is returned to the second hydraulic tank T by the boom down operation, to the low-pressure chamber of the boom cylinder 17; and
detection means configured to detect the pressure of the arm cylinder 14 and the pressure of the boom cylinder 17 in order to determine whether or not the hydraulic fluid returned to the second hydraulic tank T from the boom cylinder 17 can be regenerated during the combined operation of the boom down and the arm out.

In accordance with an embodiment of the present invention, the energy regeneration system for a construction machine further includes: a first variable flow rate control valve 21 mounted in the boom down supply flow path 16 and configured to have an open area that can be changed in response to a control signal to control the flow rate or the pressure of the hydraulic fluid supplied to the low-pressure chamber of the boom cylinder 17 from the second hydraulic pump 12; and a second variable flow rate control valve 22 mounted in the boom down return flow path 18 and configured to have an open area that can be changed in response to a control signal to control the flow rate or the pressure of the hydraulic fluid returned to the second hydraulic tank T from the high-pressure chamber of the boom cylinder 17.

In accordance with an embodiment of the present invention, the energy regeneration system for a construction machine further includes: a third variable flow rate control valve 23 mounted in the arm out supply flow path 13 and configured to have an open area that can be changed in response to a control signal to control the flow rate or the pressure of the hydraulic fluid supplied to the low-pressure chamber of the arm cylinder 14 from the first hydraulic pump 11; and a fourth variable flow rate control valve 24 mounted in the arm out return flow path 15 and configured to have an open area that can be changed in response to a control signal to control the flow rate or the pressure of the hydraulic fluid returned to the first hydraulic tank T from the high-pressure chamber of the arm cylinder 14.

In accordance with an embodiment of the present invention, the energy regeneration system for a construction machine further includes: a fifth variable flow rate control valve 25 mounted in the confluence and regeneration flow path 19 and configured to have an open area that can be changed in response to a control signal to control the flow rate or the pressure of the hydraulic fluid supplied to the low-pressure chamber of the arm cylinder 14 from the high-pressure chamber of the boom cylinder 17.

The detection means includes a first pressure sensor 26 configured to detect the pressure generated from the high-pressure chamber of the boom cylinder 17, and a second pressure sensor 27 configured to detect a discharge pressure supplied to the low-pressure chamber of the arm cylinder 14 from the first hydraulic pump 11.

In FIG. 2, a non-explained reference numeral 28 denotes a third pressure sensor that detects the pressure generated from the low-pressure chamber of the arm cylinder 14.

Hereinafter, a use example of the energy regeneration system for a construction machine in accordance with the present invention will be described in detail with reference to the companying drawings.

Referring to FIG. 2, when the construction machine performs an arm out operation, a hydraulic fluid discharged from the first hydraulic pump 11 is supplied to the small chamber, i.e., the low-pressure chamber of the arm cylinder 14 via the third variable flow rate control valve 23. In this case, the hydraulic fluid from the large chamber, i.e., the high-pressure chamber of the arm cylinder 14 is returned to the first hydraulic tank T via the fourth variable flow rate control valve 24 mounted in the arm out return flow path 15.

In the meantime, the cross-sectional areas of the openings of the third variable flow rate control valve 23 mounted in the arm out supply flow path 13 and the fourth variable flow rate control valve 24 mounted in the arm out return flow path 15 are controlled, respectively, so as to control the flow rate of the hydraulic fluid passing through the openings of the third and fourth variable flow rate control valves so that the drive of the arm cylinder 14 can be controlled.

Referring to FIG. 2, when the construction machine performs a boom down operation, the hydraulic fluid discharged from the second hydraulic pump 12 is supplied to the small chamber, i.e., the low-pressure chamber of the boom cylinder 14 via the first variable flow rate control valve 21. In this case, the hydraulic fluid from the large chamber, i.e., the high-pressure chamber of the boom cylinder 17 is returned to the second hydraulic tank T via the second variable flow rate control valve 22 mounted in the boom down return flow path 18. In this case, the hydraulic fluid to be returned to the second hydraulic tank T may flow branched off in three directions.

First, some of the hydraulic fluid discharged from the boom cylinder 17 for the purpose of being returned to the second hydraulic tank T is supplied to and regenerated in the small chamber of the arm cylinder 14 along the arm out supply flow path 13 via the fifth variable flow rate control valve 25 mounted in the confluence and regeneration flow path 19.

Second, some of the hydraulic fluid discharged from the boom cylinder 17 for the purpose of being returned to the second hydraulic tank T is re-supplied to and regenerated in the small chamber of the boom cylinder 17 along the boom down supply flow path 16 via the second variable flow rate control valve 22 mounted in the boom down return flow path 18.

Third, some of the hydraulic fluid discharged from the boom cylinder 17 for the purpose of being returned to the second hydraulic tank T is returned to the second hydraulic tank T along the boom down return flow path 18. That is, during the boom down operation, some of the hydraulic fluid discharged from the boom cylinder 17 for the purpose of being returned to the second hydraulic tank T is re-supplied to the small chamber of the boom cylinder 17 or is supplied to and regenerated in the small chamber of the arm cylinder 14 by a difference in the cross-sectional area of the boom cylinder 17.

In the meantime, the cross-sectional areas of the openings of the first variable flow rate control valve 21 mounted in the boom down supply flow path 16 and the second variable flow rate control valve 22 mounted in the boom down return flow path 18 are controlled, respectively, so as to control the flow rate of the hydraulic fluid passing through the openings of the first and second variable flow rate control valves so that the drive of the boom cylinder 17 can be controlled.

Hereinafter, the flow rate of the hydraulic fluid supplied to the arm cylinder 14 and the boom cylinder 17 from the first hydraulic pump 11 and the second hydraulic pump 12 will be described.

As shown in FIG. 2, the flow rate (Q2) of the hydraulic fluid discharged from the second hydraulic pump 12 is supplied to the small chamber of the boom cylinder 17. At this time, the flow rate of the hydraulic fluid discharged from the large chamber of the boom cylinder 17 for the purpose of being returned to the second hydraulic tank T consists of a flow rate Qa of the hydraulic fluid supplied to and regenerated in the small chamber of the arm cylinder 14, a flow rate Qc of the hydraulic fluid re-supplied to and regenerated in the small chamber of the boom cylinder 17, and a flow rate Qb of the hydraulic fluid returned to the second hydraulic tank T.

By virtue of this configuration, the arm cylinder 14 simultaneously receives the flow rate Qa of the hydraulic fluid regeneratingly supplied thereto from the boom cylinder 17 and the flow rate Q1 of the hydraulic fluid supplied thereto from the first hydraulic pump 11 so that the flow rate of the hydraulic fluid supplied to the arm cylinder 14 can be secured, thereby improving the workability of the arm out operation. In the meantime, the hydraulic fluid can be returned to the first hydraulic tank T from the large chamber of the arm cylinder 14 by a flow rate Q3 (=Q1+Qa).

As described above, the supply flow paths (meter-in) and the return flow paths (meter-out) of the boom cylinder 17 and the arm cylinder 14 are independently controlled by the first variable flow rate control valve 21 mounted in the boom down supply flow path 16 and the third variable flow rate control valve 23 mounted in the arm out supply flow path 13, and the second variable flow rate control valve 22 mounted in the boom down return flow path 18 and the fourth variable flow rate control valve 24 mounted in the arm out return flow path 15, respectively.

In the meantime, the pressures of the boom cylinder 17 and the arm cylinder 14 can be detected in real-time by the first pressure sensor 26 mounted in the boom down return flow path 18, and the third pressure sensor 28 mounted in the arm out supply flow path 13.

As shown in FIG. 3, at step S100, an operator performs the boom down and arm out operation by manipulating a manipulation lever (i.e., joystick).

At step S200, a pressure value Pa of the large chamber of the boom cylinder 17 detected by the first pressure sensor 26 is compared with a discharge pressure value P1 of the first hydraulic pump 11 detected by the second pressure sensor 27. If it is determined at step S200 that the pressure value Pa of the large chamber of the boom cylinder 17 is greater than the discharge pressure value P1 of the first hydraulic pump 11 (i.e., Pa>P1), then the program proceeds to step S300. On the contrary, if it is determined at step S200 that the pressure value Pa of the large chamber of the boom cylinder 17 is smaller than the discharge pressure value P1 of the first hydraulic pump 11 (i.e., Pa<P1), then the program proceeds to step 4300.

As can be seen at step S300, if the pressure value Pa of the large chamber of the boom cylinder 17 is greater than the discharge pressure value P1 of the first hydraulic pump 11 (i.e., Pa>P1), then the hydraulic fluid discharged from the large chamber of the boom cylinder 17 for the purpose of being returned to the second hydraulic tank T can be supplied to and regenerated in the small chamber of the arm cylinder 14. In other words, the hydraulic fluid discharged from the large chamber of the boom cylinder 17 for the purpose of being returned to the second hydraulic tank T can be supplied to and regenerated in the small chamber of the arm cylinder 14 by controlling the cross-sectional areas of the openings of the fifth variable flow rate control valve 25 mounted in the confluence and regeneration flow path 19 and the second variable flow rate control valve 22 mounted in the boom down return flow path 18, respectively.

In this case, the cross-sectional areas (i.e., A area, B area, C area, and D area) of the openings of the first, second, third, and fifth variable flow rate control valves 21, 22, 23 and 25 are controlled to be respective different values in response to a control signal applied from the outside.

Thus, during the boom down operation, the discharge pressure value of the first hydraulic pump 11 is detected through the flow rate of the hydraulic fluid returned and regeneratingly supplied to the arm cylinder 11 to control the drive of the first hydraulic pump 11, so that a power for driving the first hydraulic pump 11 driven to supply the hydraulic fluid to the arm cylinder 14 can be reduced.

As can be seen at step S400, if the pressure value Pa of the large chamber of the boom cylinder 17 is smaller than the discharge pressure value P1 of the first hydraulic pump 11 (i.e., Pa<P1), then the hydraulic fluid discharged from the large chamber of the boom cylinder 17 for the purpose of being returned to the second hydraulic tank T cannot be supplied to and regenerated in the small chamber of the arm cylinder 14. In this case, the cross-sectional areas (i.e., A′ area, B′ area, C′ area, and 0 (close)) of the openings of the first, second, third, and fifth variable flow rate control valves 21, 22, 23 and 25 are controlled to be respective different values in response to a control signal applied from the outside.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, in the energy regeneration system for a construction machine in accordance with an embodiment of the present invention, when an excavator performs a combined operation of boom down and arm out, hydraulic energy returned by the boom down operation can be supplied to the arm cylinder, thereby improving the workability of the arm out operation.

In addition, the supply flow path (meter-in) and the return flow path (meter-out) with respect to the hydraulic actuator are controlled independently, and the pressure of the hydraulic actuator is detected in real-time, thereby implementing compactness of the hydraulic system.

1. An energy regeneration system for a construction machine comprising:
first and second variable displacement hydraulic pumps;
an arm cylinder having a low-pressure chamber connected to the first hydraulic pump 11 through an arm out supply flow path;
an arm out return flow path configured to connect a high-pressure chamber of the arm cylinder to a first hydraulic tank;
a boom cylinder having a low-pressure chamber connected to the second hydraulic pump through a boom down supply flow path;
a boom down return flow path configured to connect a high-pressure chamber of the boom cylinder to a second hydraulic tank;
a confluence and regeneration flow path configured to connect the boom down return flow path and the arm out supply flow path to each other in parallel, and regeneratingly supply some of hydraulic fluid, which is returned to the second hydraulic tank by a boom down operation, to the arm out supply flow path during a combined operation of boom down and arm out;
a regeneration flow path configured to connect the boom down return flow path and the boom down supply flow path to each other in parallel, and regeneratingly supply some of hydraulic fluid, which is returned to the second hydraulic tank by the boom down operation, to the low-pressure chamber of the boom cylinder; and
detection means configured to detect the pressure of the arm cylinder and the pressure of the boom cylinder in order to determine whether or not the hydraulic fluid returned to the second hydraulic tank T from the boom cylinder can be regenerated during the combined operation of the boom down and the arm out.

2. The energy regeneration system according to claim 1, further comprising:
a first variable flow rate control valve mounted in the boom down supply flow path 16 and configured to control the hydraulic fluid supplied to the low-pressure chamber of the boom cylinder from the second hydraulic pump; and
a second variable flow rate control valve mounted in the boom down return flow path and configured to control the hydraulic fluid returned to the second hydraulic tank from the high-pressure chamber of the boom cylinder.

3. The energy regeneration system according to claim 2, further comprising:
a third variable flow rate control valve mounted in the arm out supply flow path and configured to control the hydraulic fluid supplied to the low-pressure chamber of the arm cylinder 14 from the first hydraulic pump; and
a fourth variable flow rate control valve mounted in the arm out return flow path and configured to control the hydraulic fluid returned to the first hydraulic tank from the high-pressure chamber of the arm cylinder.

4. The energy regeneration system according to claim 3, further comprising:
a fifth variable flow rate control valve mounted in the confluence and regeneration flow path and configured to control the hydraulic fluid supplied to the low-pressure chamber of the arm cylinder from the high-pressure chamber of the boom cylinder.

5. The energy regeneration system according to claim 1, wherein the detection means comprises a first pressure sensor configured to detect the pressure generated from the high-pressure chamber of the boom cylinder, and a second pressure sensor configured to a discharge pressure supplied to the low-pressure chamber of the arm cylinder from the first hydraulic pump.
